(19) United States
(12) Patent Application Publication
(10) Pub. No.: US 2022/0042774 A1
(43) Pub. Date: Feb. 10, 2022

(54) PORTABLE LASER WEAPON

(71) Applicant: HANWHA CORPORATION, Seoul (KR)

(72) Inventors: Kang In Lee, Seongnam-si (KR); Ye Ji Jung, Seongnam-si (KR); Tae Woo Kim, Seongnam-si (KR); Min Wan Jung, Seongnam-si (KR); Jae Ihn Kim, Seongnam-si (KR); Yong Soo Lee, Seongnam-si (KR); Joon Yong Cho, Seongnam-si (KR)

(73) Assignee: HANWHA CORPORATION, Seoul (KR)

(21) Appl. No.: 17/101,242

(22) Filed: Nov. 23, 2020

(30) Foreign Application Priority Data
Aug. 5, 2020 (KR) 10-2020-0097704

(51) Int. Cl. F41H 13/00

(52) U.S. Cl. CPC F41H 13/0062

(57) ABSTRACT

Proposed is a portable laser weapon. The portable laser weapon includes: a laser generation unit generating a high-power laser beam; a wearing unit having the laser generation unit therein and being able to be worn on an individual; a sighting-shooting unit receiving and shooting a laser beam generated from the laser beam generation unit; and a beam transmission cable connecting the laser generation unit and the sighting-shooting unit to each other, thereby transmitting a laser generated from the laser generation unit to the sighting-shooting unit. Accordingly, it is possible to considerably improve the usability of laser weapons by providing a laser weapon that can be operated by an individual infantryman and can shoot a high-power laser.

### CROSS REFERENCE TO RELATED APPLICATION(S)

This application claims the benefit of Korean Patent Application No. 10-2020-0097704, filed on Aug. 5, 2020, which is hereby incorporated by reference in its entirety into this application.

### BACKGROUND OF THE INVENTION

### 1. Technical Field

The present disclosure relates to a portable laser weapon.

### 2. Description of the Related Art

In general, a laser weapon is a new concept weapon system that hits a target by focusing a laser beam to the target.

Laser weapons deliver energy at the speed of light without being affected by the gravitational field.

Laser weapons that are directional energy weapons are under development into new concept weapons that can change the paradigm of war in future wars characterized by a nonlinear and small-scale decentralized battle, a non-lethal battle, a non-personal and remote proxy war, and a space war.

High-energy laser weapons are much spotlighted particularly to intercept many drones and unmanned aerial vehicles that infiltrate from remote sites.

Further, laser weapons, as compared with conventional weapons, are accompanied by less damage in the process of interception targets, so they are expected to keep developed as safe and clean future weapons.

Laser weapons have been developed as large-scale and high-power laser weapons that are usually loaded on platforms such as a trailer, a ship, and an airplane to secure power that can hit and destroy targets.

However, since existing laser weapons have been developed as large-scale and high-power laser weapons that are usually loaded on platforms such as a trailer, a ship, and an airplane to secure power that can hit and destroy targets, there is a problem that individuals have difficult to carry and use them.

Further, a small cost is needed to operate the laser weapons that are loaded on platforms such as a trailer, a ship, or an airplane, but a large cost is required in the manufacturing process and it is accompanied with an economic burden to manufacture a large quantity of laser weapons.

In particular, if the range is increased, the required power of a laser weapon rapidly increases, so it is also a difficult issue to increase the range.

### Document of Related Art

### Patent Document

Patent Document 1) Korean Patent Application Publication No. 10-1991-0012648 “Laser beam weapon” (published on Aug. 8, 1991)

### SUMMARY OF THE INVENTION

An objective of the present disclosure is to provide a portable laser weapon in which a laser generation unit generating a high-power laser and a sighting-shooting unit sighting and shooting laser to a target are separated and the laser generation unit is configured to be worn by an individual, thereby being able to shoot a high-power laser.

In order to achieve the objects, a portable laser weapon of the present disclosure includes: a laser generation unit generating a high-power laser beam; a wearing unit having the laser generation unit therein and being able to be worn on an individual; a sighting-shooting unit receiving and shooting a laser beam generated from the laser beam generation unit; and a beam transmission cable connecting the laser generation unit and the sighting-shooting unit to each other, thereby transmitting a laser generated from the laser generation unit to the sighting-shooting unit.

The wearing unit may include: a backpack casing having the laser generation unit therein and configured to be worn on the back of an individual; and shoulder belts respectively disposed on both sides of the backpack casing to be worn on the shoulders of an individual.

The laser generation unit may include: a laser generator generating a laser beam; a control board controlling operation of the laser generator; a chargeable battery supplying power to the laser generator and the control board; and a cooler cooling the laser generator.

The cooler may be an air-cooling cooler.

The air-cooling cooler may include: a blowing fan suctioning external air into the wearing unit and discharging air in the wearing unit to the outside; and heat dissipation fins attached to an outer side of the laser generator.

The cooler may include a temperature sensor sensing temperature of the laser generator, the control board may receive in real time temperature information of the laser generator from the temperature sensor, may operate the cooler when the temperature of the laser generator is a predetermined temperature or higher, and may stop the air-cooling cooler when the temperature of the laser generator is the predetermined temperature or lower.

The control board selectively may control the laser generator to generate a laser beam continuously or quasi-continuously remaining power, etc. of the chargeable battery.

The control board may enable a laser beam to be continuously generated when the remaining power of the chargeable battery is a predetermined amount or more and a shot signal is applied, and may make a laser beam be generated with predetermined intervals when the remaining power of the chargeable battery is less than the predetermined amount and a shot signal is applied.

The beam transmission cable may be an optical-control integrated cable including: an optical fiber cable member transmitting a laser beam generated from the laser generation unit to the sighting-shooting unit; a shot control cable member connecting the control board and the beam shot control switch of the sighting-shooting unit to each other; and a cover member covering the optical fiber cable member and the shot control cable member.

A high-power laser optical window finally outputting a laser beam may be disposed at an end of the sighting-shooting unit

The sighting-shooting unit may include: a distance measurer measuring a distance between a target and an outlet of a laser beam; and a focuser adjusting a focal distance of a laser beam generated and shot from the laser generation unit to the target, and the focuser may adjust a focus of a laser beam such that the laser beam is focused on the target using distance information measured by the distance measurer.

The focuser may be connected to the distance measurer through an automatic focus correction control line and may feed back the fact that a focus has been formed at a current distance measured by the distance measurer through the automatic focus correction control line.

The sighting-shooting unit may include a laser aimer emitting a target-aiming laser to a target.

According to the present disclosure, there is an effect that it is possible to considerably improve the usability of laser weapons by providing a laser weapon that can be operated by an individual infantryman and can shoot a high-power laser.

According to the present disclosure, there is an effect that it is possible to remarkably improve a penetration rate of laser weapons because it is possible to supply an inexpensive laser weapon that enables an individual infantryman to intercept a bomb or an unmanned vehicle at a short distance.

### BRIEF DESCRIPTION OF THE DRAWINGS

The above and other objectives, features and advantages of the present disclosure will be more clearly understood from the following detailed description taken in conjunction with the accompanying drawings, in which:

FIG. 1 is a perspective view showing an embodiment of a portable laser weapon according to the present disclosure;

FIG. 2 is a schematic view showing an embodiment of a portable laser weapon according to the present disclosure:

FIG. 3 is a schematic view showing an embodiment of a laser generation unit of a portable laser weapon according to the present disclosure;

FIG. 4 is a schematic view showing an embodiment of a sighting-shooting unit of a portable laser weapon according to the present disclosure; and

FIG. 5 is a schematic view showing an example of using a portable laser weapon according to the present disclosure.

### DESCRIPTION OF THE PREFERRED EMBODIMENTS

The present disclosure is described hereafter.

Exemplary embodiments of the present disclosure are described hereafter in detail with reference to the accompanying drawings. Before describing the present disclosure, it should be noted that the terms or terminologies used herein and claims should not be construed as common meanings or the meanings in dictionaries. Therefore, the configurations described in the embodiments and drawings of the present disclosure are merely most preferable embodiments but do not represent all of the technical spirit of the present invention. Thus, it should be understood that the present disclosure should be construed as including all the changes, equivalents, and substitutions included in the spirit and scope of the present disclosure at the time of filing this application.

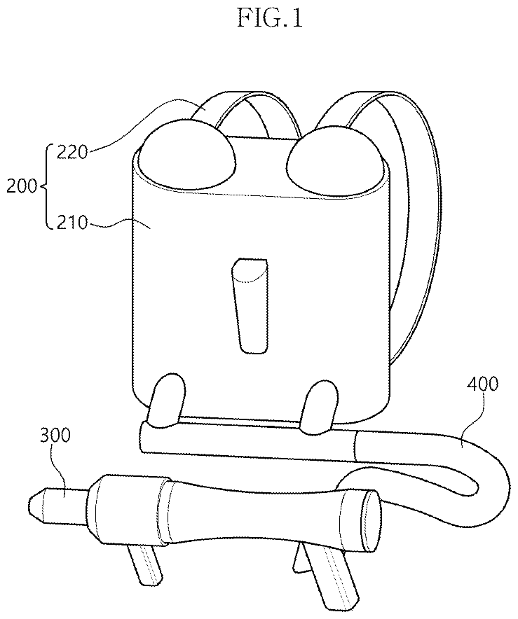

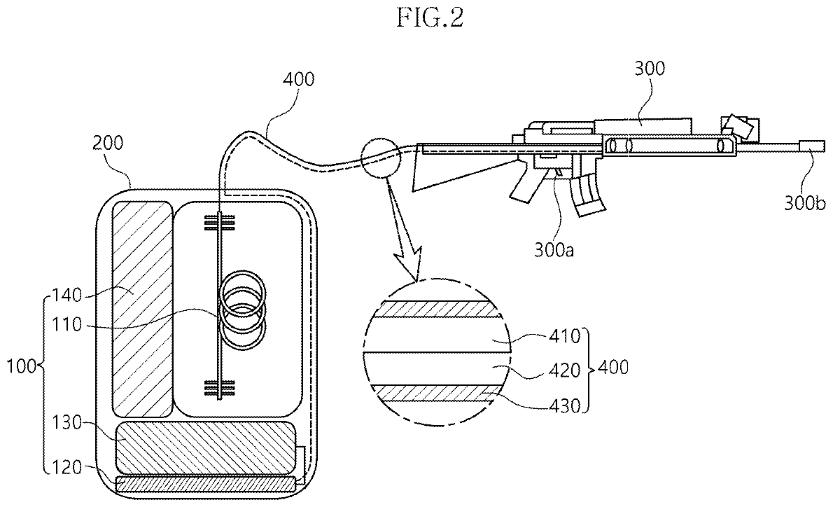

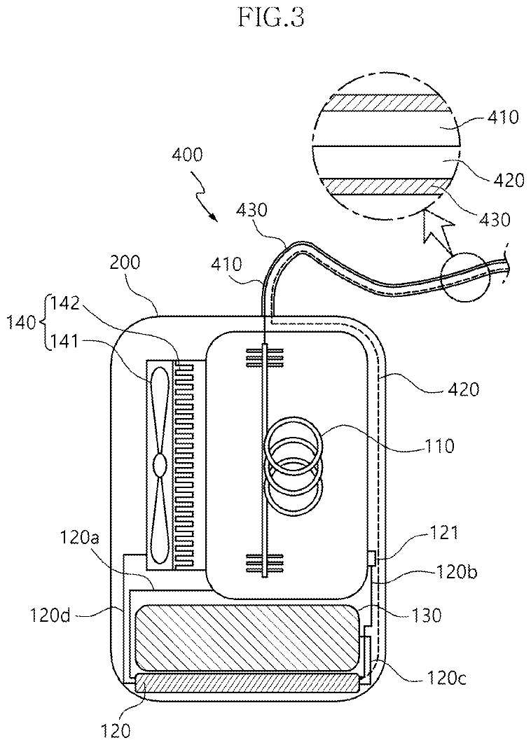

FIG. 1 is a perspective view showing an embodiment of a portable laser weapon according to the present disclosure, FIG. 2 is a schematic view showing an embodiment of a portable laser weapon according to the present disclosure, and FIG. 3 is a schematic view showing an embodiment of a laser generation unit 100 of a portable laser weapon according to the present disclosure.

An embodiment of a portable laser weapon according to the present disclosure is described hereafter in detail with reference to FIGS. 1 to 3.

An embodiment of a portable laser weapon according to the present disclosure includes: a laser generation unit 100 that generates a high-power laser beam; a wearing unit 200 in which the laser generation unit 100 is disposed and that an individual can wear; a sighting-shooting unit 300 that shoots the laser beam generated by the laser generation unit 100; and a beam transmission cable 400 that transmits the laser beam generated by the laser generation unit 100 to the sighting-shooting unit 300.

The beam transmission cable 400 connects the laser generation unit 100 and the sighting-shooting unit 300 to transmit the laser generated by the laser generation unit 100 to the sighting-shooting unit 300 so that the laser beam can be shot through the sighting-shooting unit 300.

The wearing unit 200, for example, may be formed in a backpack type that an individual wears on the back.

The wearing unit 200 includes a backpack casing 210 in which the laser generation unit 100 is disposed and that is worn on the back of a user and shoulder belts 220 respectively disposed on both sides of the backpack casing to be worn on the shoulders of an individual.

Since the wearing unit 200 is a backpack type that an individual wears on the back, an individual can stably carry a weight body including the laser generation unit 100.

It should be noted that the wearing unit 200 can be modified into various backpack types that users wear on the back and are well known in the art.

The sighting-shooting unit 300 includes a rifle-shaped body that an individual holds with hands to be able to shoot a laser beam to a target.

It should be noted that the sighting-shooting unit 300 can be modified in various types including well-known rifle, gun, etc.

The body of the sighting-shooting unit 300 has a handle that an individual can hold to use and a beam shot control switch 300a that controls shot of a laser beam by controlling the operation of the laser generation unit 100 is disposed at the handle.

That is, the beam shot control switch 300a that applies a generation signal of a laser or applies a stop signal of a laser is disposed at the body of the sighting-shooting unit 300. The beam shot control switch 300a controls shot of a laser beam by controlling the operation of the sighting-shooting unit 300 such that a laser beam can be continuously or quasi-continuously shot.

When a button of a button type switch is pressed or a pressing portion like a trigger is pressed, the beam shot control switch 300a operates the laser generation unit 100 such that a laser beam can be shot through the exit of the sighting-shooting unit 300. When the force pressing the button or the pressing portion is removed, the beam shot control switch 300a stops the operation of the laser generation unit 100.

The laser generation unit 100 includes a laser generator 110 that generates a laser beam, a control board 120 that controls the operation of the laser generator 110, and a chargeable battery 130 that supplies power to the laser generator 110 and the control board 120.

The laser generator 110 is a well-known laser generator 110 that can continuously generate a laser and generates a high-power laser beam, so it is not described in more detail.

The laser generation unit 100 further includes a cooler 140 that cools the laser generation unit 110 and the cooler 140, for example, an air-cooling cooler.

The air-cooling cooler includes a blowing fan 141 that suctions external air into the wearing unit 200 and discharging the air in the wearing unit 200 to the outside.

The air-cooling cooler may further include heat dissipation fins 142 attached to the outer side of the laser generator 110.

It should be noted that the air-cooling cooler may use not only an air-cooling structure including the flowing fan 141 and the heat dissipation fins 142, but also other well-known air-cooler such as a conduction-cooling structure.

The air-cooling cooler includes a temperature sensor 121 that senses the temperature of the laser generator 110 and is connected to the control board 120 such that the operation thereof is controlled by the control board 120.

That is, the chargeable battery 130 can supply power to the laser generator 110, the control board 120, and the air-cooling cooler and the control board 120 can control the operation of the laser generator 110 and the air-cooling cooler.

The control board 120 is connected to the laser generator 110 through a laser generator control cable 120a, thereby being able to control the operation state of the entire laser generator 110 and can check the operation and abnormality state of equipment.

The control board 120 is connected to the air-cooling cooler through a cooing control cable 120d and is connected to the temperature sensor 121 through a cable 120b for sensing, thereby being able to control the operation of the air-cooling cooler and control the operation of the laser generator 110.

The control board 120 receives in real time temperature information of the laser generator 110 from the temperature sensor 121. The control board 120 operates the air-cooling cooler such that the laser generator 110 can be stably operated without the temperature thereof increased to a predetermined temperature or higher when the temperature of the laser generator 110 is determined as being the predetermined temperature or higher. Further, the control board 120 stops the air-cooling cooler when the temperature of the laser generator 110 is the predetermined temperature or lower.

The air-cooling cooler consumes a lot of power of the chargeable battery 130 if it is continuously operated, so it is operated only when the temperature of the laser generator 110 is the predetermined temperature or higher so that the power consumption of the chargeable battery 130 can be minimized and sufficient operable time of the laser generator 110 can be secure.

The chargeable battery 130 is connected to the control board 120 through a power cable 120c, thereby supplying power to the control board 120 and supplying power to devices that are used to shoot a laser beam such as the laser beam generator 110, the air-cooling cooler, and the beam shot control switch 300a through the control board 120.

The control board 120 can be supplied with power from the chargeable battery 130 through the power cable 120c and can monitor the charge/discharge state, the battery state, etc. of the chargeable battery 130.

The control board 120 can selectively control the laser generator 110 to generate a laser beam continuously or quasi-continuously, that is, with predetermined intervals by checking the state information such as the charge/discharge state of the chargeable battery 130, that is, the remaining power of the chargeable battery 130.

When the remaining power of the chargeable battery 130 is a predetermined amount or more and a shot signal is applied, the control board 120 enables a laser beam to be continuously generated. When the remaining power of the chargeable battery 130 is less than the predetermined amount and a shot signal is applied, the control board 120 causes a laser beam be generated with predetermined intervals. Accordingly, it is possible to maximally secure the operation time of the laser generator 110 while efficiently using the chargeable battery 130.

It should be noted that the chargeable battery can be charged by separately connecting a charging cable or a charging adaptor and it should be noted that the charging cable and the charging adaptor may be modified into well-known structures in various ways.

The beam transmission cable 400 includes an optical fiber cable member 410 transmitting the laser beam generated from the laser generation unit 100 to the sighting-shooting unit 300, and a shot control cable member 420 connecting the control board 120 and the beam shot control switch 300a to each other.

The optical cable member 410 transmits the laser beam generated from the laser generation unit 100 to the sighting-shooting unit 300 so that the laser beam can be shot through the sighting-shooting unit 300.

The control cable member, which is an optical-control integrated cable including a cover member 430 covering the optical fiber cable member 410 and the shot control cable member 420, transmits a laser beam to the sighting-shooting unit 300 and transmits a shot signal of the sighting-shooting unit 300 to the control board 120.

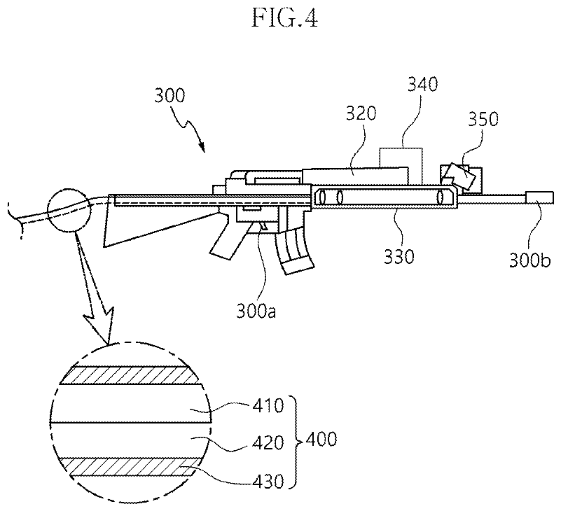

FIG. 4 is a schematic view showing an embodiment of the sighting-shooting unit 300 of the portable laser weapon according to the present disclosure. Referring to FIG. 4, the sighting-shooting unit 300, for example, has a rifle-shaped rifle body 310 to secure convenience of operation and a high accuracy rate.

The sighting-shooting unit 300 receives a laser beam from the beam transmission cable 400, that is, the optical fiber cable member and shoots a laser through a laser shooting part 300b disposed at the end thereof.

The laser shooting part 300b, for example, is a high-power laser optical window that can output a high-power laser beam.

The high-power laser optical window, which is a laser optical window that finally outputs a high-power laser beam from the sighting-shooting unit 300, prevents the body of the sighting-shooting unit 300 from being damaged when high-power laser beam is shot, and enables a high-power laser beam to be stably shot.

As described above, the sighting-shooting unit 300 has the beam shot control switch 300a and the beam shot control switch 300a is connected to the control board 120 through the shot control cable member 420 of the optical-control integrated cable, thereby transmitting a shot signal generated by operation by an individual infantryman to the control board 120 and controls operation of the laser generator 110.

The sighting-shooting unit 300 has a distance measurer 320 that measures the distance between a target and the outlet of a laser beam.

It should be noted that the distance measurer 320, for example, is a laser distance measurer and may be modified in various ways using well-known distance measurer that can measure a distance.

The sighting-shooting unit 300 has a focuser 330 that is connected to the optical fiber cable member 410 and adjusts the focal distance of the laser beam generated from the laser generator 110.

The focuser 330 focuses a laser beam on a target using distance information measured by the distance measurer 320.

The focuser 330, for example, includes an automatic focus correction optical system including a movable focus correction lens and focuses a laser beam on a target using distance information measured by the distance measurer 320.

The focuser 330 is automatically controlled by the control board 120 to focus a laser beam on a target by moving the focus correction lens using distance information measured by the distance measurer 320.

The focuser 330 is connected to the distance measurer 320 through an automatic focus correction control line 340 and feeds back the fact that the focus has been formed at the current distance measured by the distance measurer 320 through the automatic focus correction control line 340 so that the focus keeps formed at the distance and is stably maintained on the target.

The focuser 330, the distance measurer 320, and the automatic focus correction control line 340 are connected to the control board 120 through the shot control cable member 420.

The shot control cable member 420 includes a plurality of cables respectively connecting the control board 120 to the shot control switch, the focuser 330, the distance measurer 320, and the automatic focus correction control line 340, thereby transmitting not only the short signal of the shot control switch, but also the distance information measured by the distance measurer 320 and the information determined through the automatic focus correction control line 340 to the control board 120 such that the laser beam shot by controlling the automatic focus correction optical system through the control board 120 can be accurately focused on a target.

The sighting-shooting unit 300 may further include a laser aimer 350 that emits a target-aiming laser to a target.

The laser aimer 350 emits a target-aiming laser to a target so that an individual can recognize the target and can accurately shoot a laser beam to the target.

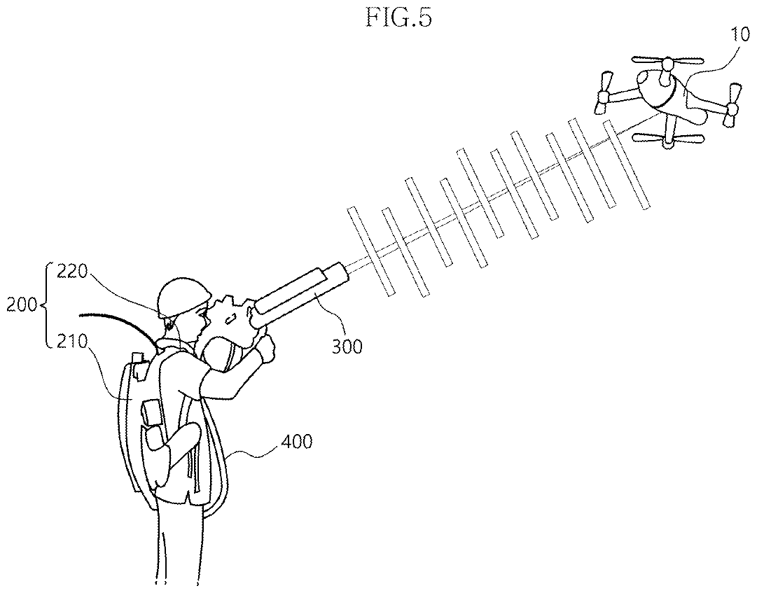

FIG. 5 is a schematic view showing an example of using a portable laser weapon according to the present disclosure. Referring to FIGS. 2 to 5, an individual infantryman can shoot a laser beam to a target 10 while holding the sighting-shooting unit 300 by hand and carrying the backpack-shaped wearing unit 200 of the portable laser weapon according to the present disclosure on the back.

The individual infantry man operates the laser generator 110 by operating the beam shot control switch 300a of the sighting-shooting unit 300 such that a laser beam can be shot. In this case, the control board controls the automatic focus correction optical system on the basis of the distance information measured by the distance measurer 320 and the information obtained through the automatic focus correction control line 340 such that the shot laser beam can be accurately focused on the target 10.

According to the present disclosure, it is possible to considerably improve the usability of laser weapons by providing a laser weapon that can be operated by an individual infantryman and can shoot a high-power laser.

According to the present disclosure, it is possible to remarkably improve a penetration rate of laser weapons because it is possible to supply an inexpensive laser weapon that enables an individual infantryman to intercept a bomb or an unmanned vehicle at a short distance.

The present disclosure is not limited to the embodiments described above and may be modified in various ways without departing from the scope of the present disclosure and the modifications should be construed as being included in the present disclosure.

What is claimed is:

1. A portable laser weapon comprising:
a laser generation unit generating a high-power laser beam;
a wearing unit having the laser generation unit therein and being able to be worn on an individual;
a sighting-shooting unit receiving and shooting a laser beam generated from the laser beam generation unit; and
a beam transmission cable connecting the laser generation unit and the sighting-shooting unit to each other, thereby transmitting a laser generated from the laser generation unit to the sighting-shooting unit.

2. The portable laser weapon of claim 1, wherein the wearing unit comprises:
a backpack casing having the laser generation unit therein and configured to be worn on the back of an individual; and
shoulder belts respectively disposed on both sides of the backpack casing to be worn on the shoulders of an individual.

3. The portable laser weapon of claim 1, wherein the laser generation unit comprises:
a laser generator generating a laser beam;
a control board controlling operation of the laser generator;
a chargeable battery supplying power to the laser generator and the control board; and
a cooler cooling the laser generator.

4. The portable laser weapon of claim 3, wherein the cooler is an air-cooling cooler.

5. The portable laser weapon of claim 4, wherein the air-cooling cooler comprises:
a blowing fan suctioning external air into the wearing unit and discharging air in the wearing unit to the outside; and
heat dissipation fins attached to an outer side of the laser generator.

6. The portable laser weapon of claim 3, wherein the cooler comprises a temperature sensor sensing temperature of the laser generator, and
the control board receives in real time temperature information of the laser generator from the temperature sensor, operates the cooler when the temperature of the laser generator is a predetermined temperature or higher, and stops the air-cooling cooler when the temperature of the laser generator is the predetermined temperature or lower.

7. The portable laser weapon of claim 3, wherein the control board selectively controls the laser generator to generate a laser beam continuously or quasi-continuously remaining power, etc. of the chargeable battery.

8. The portable laser weapon of claim 7, wherein the control board enables a laser beam to be continuously generated when the remaining power of the chargeable battery is a predetermined amount or more and a shot signal is applied, and causes a laser beam be generated with predetermined intervals when the remaining power of the chargeable battery is less than the predetermined amount and a shot signal is applied.

9. The portable laser weapon of claim 3, wherein the beam transmission cable is an optical-control integrated cable comprising:
an optical fiber cable member transmitting a laser beam generated from the laser generation unit to the sighting-shooting unit;
a shot control cable member connecting the control board and the beam shot control switch of the sighting-shooting unit to each other; and
a cover member covering the optical fiber cable member and the shot control cable member.

10. The portable laser weapon of claim 1, wherein a high-power laser optical window finally outputting a laser beam is disposed at an end of the sighting-shooting unit.

11. The portable laser weapon of claim 1, wherein the sighting-shooting unit comprises:
a distance measurer measuring a distance between a target and an outlet of a laser beam; and
a focuser adjusting a focal distance of a laser beam generated and shot from the laser generation unit to the target,
wherein the focuser adjusts a focus of a laser beam such that the laser beam is focused on the target using distance information measured by the distance measurer.

12. The portable laser weapon of claim 11, wherein the focuser is connected to the distance measurer through an automatic focus correction control line and feeds back the fact that a focus has been formed at a current distance measured by the distance measurer through the automatic focus correction control line.

13. The portable laser weapon of claim 1, wherein the sighting-shooting unit comprises a laser aimer emitting a target-aiming laser to a target.
